(19) United States
(12) Patent Application Publication
(10) Pub. No.: US 2011/0009131 A1
(43) Pub. Date: Jan. 13, 2011

(54) Permission-Based Mobile-Device Positioning System and Method Thereof

(76) Inventor: De Lieh Pan, Taipei (TW)

Correspondence Address: SCHMEISER OLSEN & WATTS, 18 E UNIVERSITY DRIVE, SUITE # 101, MESA, AZ, 85201, US

(21) Appl. No.: 12/828,566

(22) Filed: Jul. 1, 2010

(30) Foreign Application Priority Data
Jul. 9, 2009 (TW) 098123274

(51) Int. Cl. H04W 24/00

(52) U.S. Cl. 455/456.3

(57) ABSTRACT

The present invention discloses a permission-based mobile-device positioning system and a method thereof. A sender uses an electronic mobile device to make a request for positioning service and/or a request for inputting contents the sender intends to issue. A communication provider provides positional information for the sender and receives the contents input by the sender. A primary server receives the positional information and contents of the sender from the communication provider, uses a member database to verify membership of the sender, and uses a positional information comparison database to compare the positional information with a built-in geographic data to provide corresponding information. A webpage server publishes the positional information and contents. Alternatively, an edit/transmit server edits the positional information and contents into edited contents and transmits the edited contents to one or more recipients via an issue channel.

### BACKGROUND OF THE INVENTION

1. Field of the Invention

The present invention relates to a permission-based mobile-device positioning system and a method thereof, particularly to a system and a method, wherein the communication provider passively positions a mobile device at a user's request and uses application programs to edit and transmit the positional information and related contents, whereby the positional information and related contents can be received or exchanged by terminal devices in various ways.

2. Description of the Related Art

The Global Positioning System (GPS) is a space-based wireless positioning system usually applied to navigation and time conversion. The GPS system can provide reliable information of location, time and speed in all weather and at all times and anywhere. The GPS system can also provide consistent values of the longitude and latitude globally.

The GPS system provides accurate and continuous 3D positional data via measuring the time by which wireless signal travels between each satellite and the user. The receiver of the GPS system receives the information from several satellites and converts the information into the 3D data of position, speed and time.

The electronic mobile devices, such as PDA (Personal Digital Assistant), satellite-based portable navigation devices and laptop computers, have been very popular now. Among them, the satellite-based portable navigation devices make use of the GPS systems.

The users of the mobile devices without the GPS function of course do not enjoy the convenience of the GPS system. At present, all the electronic mobile devices with GPS function perform positioning activities actively. Once the electronic mobile device is started, the GPS system thereof begins to work automatically. Thus, the electronic mobile device is tracked by the satellites actively. Generally, the GPS system separately provides positional information for individual users. Only few mobile devices can share GPS information with each other. For most of electronic mobile devices with the GPS function, the user can neither acquire the positional information of other electronic devices nor share positional information with others but can only learn his own positional information. When one needs to know another's positional information, the other side can only describe the location vocally. However, the positional information cannot be clearly described or learned when either of the two sides is not familiar with the described location. In such a case, both sides are hard to effectively exchange positional information in realtime.

Accordingly, the present invention proposes a fast passive-type positioning system, wherein the users use an application program to edit the contents and interlink each other, whereby the users can use their terminal electronic devices to share the positional information in various ways, and whereby are overcome the abovementioned problems of the GPS system.

### SUMMARY OF THE INVENTION

One objective of the present invention is to provide a permission-based mobile-device positioning system and a method thereof, wherein the communication provider provides positioning service and presents related contents on a webpage, whereby a user can acquire and record the positional information via an electronic mobile device, and whereby the user and others can browse the positional information.

Another objective of the present invention is to provide a permission-based mobile-device positioning system and a method thereof, wherein the communication provider provides positioning service, and wherein a user can acquire the positional information via an electronic mobile device, and wherein an edit/transmit server edits and transmits the positional information and related contents of the locked-on target, and wherein the recipient can receive the positional information and related contents of the locked-on target in various ways, and wherein the users can transmit information to each other.

To achieve the abovementioned objectives, the present invention proposes a permission-based mobile-device positioning system, which comprises a communication provider providing positioning service and content-input service according to a request of an electronic mobile device of a sender; a primary server receiving the positional information and related contents of the sender from the communication provider; a member database storing membership authentication data and predetermined recipients of the sender and comparing the membership authentication data with the sender's personal data sent out by the primary server; a positional information comparison database comparing the geographic data stored thereinside with the sender's positional information acquired by the primary server, and providing corresponding information; a webpage server storing the positional information and related contents of an authenticated sender and supporting the publishing of the positional information and related contents; an edit/transmit server editing the positional information and related contents of the authenticated sender and transmitting the edited contents via an issue channel to one or more recipients.

The present invention also proposes a permission-based mobile-device positioning method, which at least comprises the following steps: Step 1: a sender using an electronic mobile device to make a request for positioning service and/or a request for inputting the contents the sender intends to issue; Step 2: a communication provider providing positioning service for the sender and receiving the input contents; Step 3: a primary server receiving the positional information and related contents of the sender from the communication provider, using a member database to verify the personal data of the sender, and using a positional information comparison database to compare the positional information with the built-in geographic information, and providing corresponding information; Step 4: a webpage server publishing the positional information and related contents, and/or an edit/transmit server editing the positional information and related contents and transmitting the edited contents to an issue channel; and Step 5: the issue channel issuing the edited contents to one or more recipients.

The sender asks the communication provider to provide positioning service via using an electronic mobile device to select the service items, send a message to a universal access number, or dial the universal access number. The communication provider obtains the positional information of the electronic mobile device of the sender from the telecommunication network. Alternatively, the sender obtains the positional information from the GPS system of the electronic mobile device and uses an application program to input the positional information and related contents to the electronic mobile device. Then, the electronic mobile device transmits the positional information and related contents to the communication provider via a wired or wireless network.

The content input by the sender may be text, voice, audio/video data, pictures, or a combination thereof. The positional information comparison database receives the positional information and compares the positional information with its own data to provide coordinates, an electronic map, topographic information, landscapes and an address.

The webpage server includes a voice display unit, an audio/video display unit, a text display unit and an electronic map display unit. The edit/transmit server includes an SMS (Short Message Service) edit/transmit unit and an MMS (Multimedia Message Service) edit/transmit unit. The content edited by the SMS edit/transmit unit may be text, audio/video data, graphs, animation, or a combination thereof.

In the present invention, the communication provider passively provides positioning service for the electronic mobile device of a sender. The user can acquire the positional information either through the electronic mobile device or via the GPS system of the electronic mobile device. The user uses an application program to input the positional information and related contents into the electronic mobile device, and the electronic mobile device transmits the positional information and related contents to the communication provider via a wired or wireless network. The communication provider uses the webpage server to publish the positional information and related contents on webpages, whereby the user can record the information and others can browse the information. Alternatively, the user uses the SMS edit/transmit unit and the MMS edit/transmit unit of the edit/transmit server to edit and transmit the positional information and related contents. The recipient can receive the positional information and related contents of the locked-on target via various ways. Further, the recipient can exchange information with the sender in realtime.

### BRIEF DESCRIPTION OF THE DRAWINGS

FIG. 1 is a block diagram schematically showing the architecture of a permission-based mobile-device positioning system according to the present invention;

FIG. 2 is a diagram schematically showing a user interface of a permission-based mobile-device positioning system according to the present invention; and

FIG. 3 is a flowchart of a permission-based mobile-device positioning method according to the present invention.

### DETAILED DESCRIPTION OF THE INVENTION

Below, the technical contents of the present invention are described in detail with the embodiments. However, it should be understood that the embodiments are only to exemplify the present invention but not to limit the scope of the present invention.

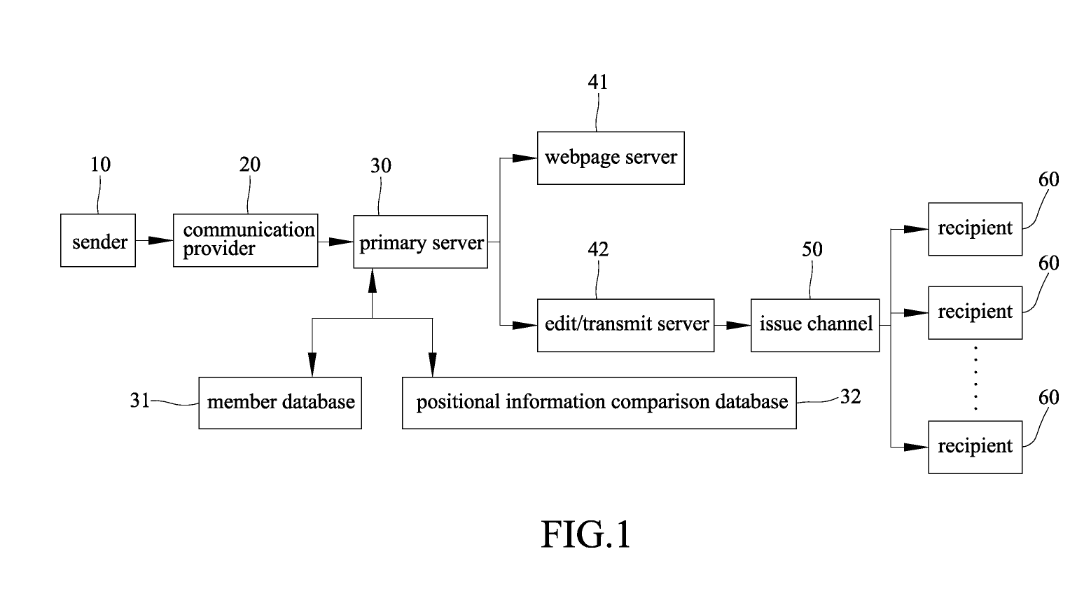

The present invention proposes a permission-based mobile-device positioning system and a method thereof, and embodiments are used to demonstrate that the abovementioned objectives can be achieved by the present invention and prove the practicability of the present invention. Refer to FIG. 1 a block diagram schematically showing the architecture of a permission-based mobile-device positioning system according to the present invention.

The system of the present invention comprises a communication provider 20, a primary server 30, a member database 31, a positional information comparison database 32, a webpage server 41 and an edit/transmit server 42.

The communication provider 20 may be a telecommunication provider or an Internet service provider. The communication provider 20 receives from a sender 10 a request for positioning an electronic mobile device, provides positioning service and content-input service for the sender 10. The content input by the sender 10 may be text, voice, audio/video data, pictures, or a combination thereof.

The electronic mobile device may be a communication device or a wireless Internet-access device, such as a mobile phone, PDA (Personal Digital Assistant), or a portable computer. The sender 10 uses the electronic mobile device to ask the communication provider 20 to provide positioning service via selecting service items provided by the communication provider 20, sending a short message to a universal access number, or dialing the universal access number. The communication provider 20 obtains the positional information of the sender 10 via the telecommunication network. For example, the communication provider 20 utilizes the triangulation technology and the GSM access points to obtain the positional information. The accuracy of the GSM triangulation technology is weaker than that of the GSP technology. However, the GSM triangulation technology has fewer blind spots. For the GSM triangulation technology, positioning is available as long as there are GSM access points. The error of the GSM triangulation technology is within 300 meters. The GSM triangulation technology performs positioning via measuring the time by which a signal is transmitted from an access point to a sender. The GSM triangulation technology can position a sender 10 inside a building.

The sender 10 may also use the GPS system built in the electronic mobile device to perform positioning and then uses the application program built in the electronic mobile device to input the positional information and related contents to the communication provider 20 via a wired or wireless communication network.

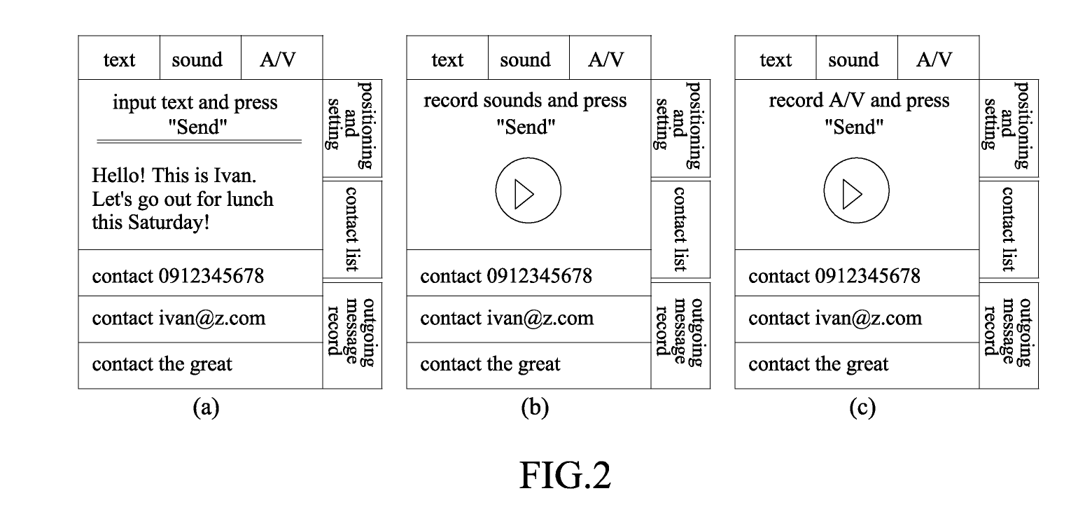

The sender 10 may undertake the abovementioned operations, using a transmit/receive application program inside the electronic mobile device. The sender 10 can use the transmit/receive application program to request a positioning service, transmit or receive contents. Thereby, all the operations are integrated in the application program. After membership authentication, the application programs of different electronic mobile devices can independently transmit positional information or contents, which contain text, voice or audio/video data, to each other. The application program can also directly present the contents. Refer to FIG. 2 for a user interface of the transmit/receive application program. The user interface of the transmit/receive application program includes (a) text, (b) voice and (c) audio/video operation items in addition to a positioning and setting item. As shown in the user interface, the contacts include a mobile phone, an email address and a member having the same application program top down.

The primary server 30 receives the positional information and related contents of a sender 10 sent out by the communication provider 20.

The member database 31 stores the membership authentication data of senders 10 and the setting of each sender 10. The member database 31 compares the sender's personal data transmitted by the primary server 30, such as the telephone number, MAC code or member account number of a sender 10, with the membership authentication data to authenticate the sender 10.

The positional information comparison database 32 compares the sender's positional information obtained by the primary server 30 with the geographic data built therein to provide the corresponding information, such as the coordinates, electronic map, landscape and address.

The webpage server 41 stores the positional information and related contents of an authenticated sender 10, which is received from the primary server 30, and supports the publishing of the positional information and related contents. The webpage server 41 includes a voice display unit, an audio/video display unit, a text display unit (displaying SMS, coordinates, landscape description, etc.) and an electronic map display unit. The webpage server 41 allows any person or the authenticated persons to browse the contents uploaded by the sender 10 via the Internet.

The edit/transmit server 42 edits the positional information and related contents of the authenticated sender 10, which is received from the primary server 30, and transmits the edited contents to one or more recipients 60 via an issue channel 50. The issue channel 50 may be a telecommunication provider or an Internet service provider. The edit/transmit server 42 includes an SMS (Short Message Service) edit/transmit unit and an MMS (Multimedia Message Service) edit/transmit unit. The content edited by the SMS edit/transmit unit may be text, audio/video data, pictures, animation, or a combination thereof. For example, the SMS edit/transmit unit can transmit a message in form of text in realtime. The MMS edit/transmit unit respectively edits the original data of text, pictures (chromatic or monochromatic), sounds (human voice or music) and video data into a text short message, an audio/video short message, an MSN message, and an email of a mobile phone. The MMS edit/transmit unit may also edits the original data into a format that the application program or the compatible application program can accept. Thereby, the recipients 60 can browse the information. Further, the recipients 60 can respond to the sender 10 or exchange data with the sender 10 in realtime via the communication provider 20 in the same way and with the same device, as mentioned above.

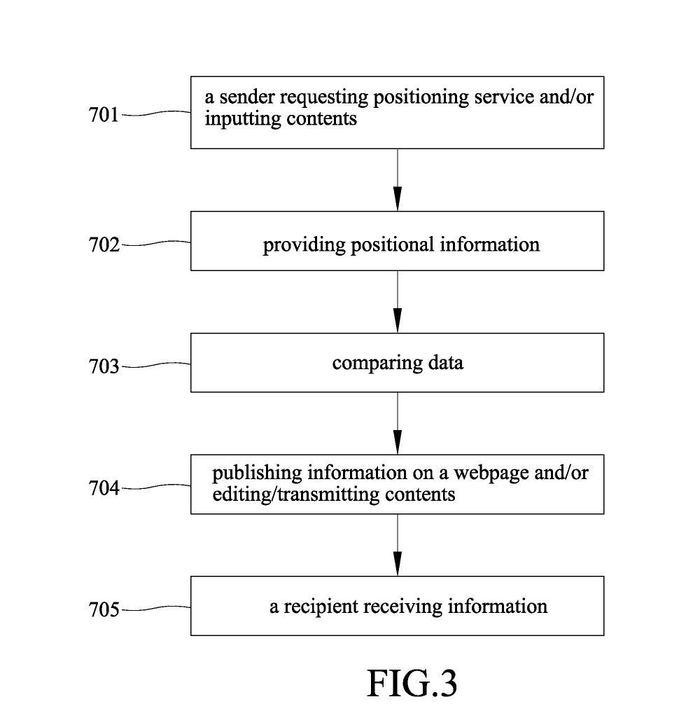

Refer to FIG. 3. The present invention also proposes a permission-based mobile-device positioning method, which at least comprises the following steps.

Step 701: A sender 10 uses an electronic mobile device to make a request to a communication provider 20 for positioning service and/or inputting the contents the sender 10 intends to issue. The sender 10 can open or close the positional information via an application program, a service unit, a selection menu, or a vocal system of a universal access number. If the sender 10 closes the positional information, the communication provider 20 conceals the positional information and only presents the input contents. The content input by the sender 10 may be text, voice, audio/video data, pictures, or a combination thereof.

Step 702: The communication provider 20 provides positioning service for the sender 10 and receives the contents input by the sender 10. The communication provider 20 obtains the positional information of the sender's electronic mobile device via the telecommunication network. The communication provider 20 may use the GSM access points and the triangulation method to obtain the positional information. Alternatively, the sender 10 directly uses the GPS system built in the electronic mobile device thereof to obtain his own positional information. The sender 10 uses the electronic mobile device or the application program to edit the information into text, voice, or audio/video data. Via the above-mentioned system, the sender 10 issues or publishes [the positional information], [the positional information+text and/or audio/video data], or [text and/or audio/video data without the positional information].

Step 703: A primary server 30 receives the positional information and related contents of the sender 10 from the communication provider 20. The primary server 30 uses a member database 31 to verify the personal data of the sender 10. The process would not undertake the succeeding activities of edit, display, issue, etc. unless the primary server 30 has compared the personal data of the sender 10 with the member account, the mobile phone number or the built-in device number (such as the MAC code), which is stored in the member database 31, and confirmed the identity of the sender 10. The primary server 30 uses a positional information comparison database 32 to compare the positional information with the built-in geographic data and then provides corresponding information, such as coordinates, an electronic map, topographic information, landscapes and an address. If the sender 10 asks for positioning service in Step 701, the communication provider 20 or the GPS system only provides the values of the longitude and latitude. Thus, the primary server 30 uses the positional information comparison database 32 to compare the values of the longitude and latitude with the built-in geographic data and then provides corresponding information, such as coordinates, an electronic map, topographic information, landscapes and an address. For example, the positional information comparison database 32 may provide an approximate address “No. 7, Sec. 5, Xinyi Rd., 101 building, Taipei City” for the values of the longitude and latitude “E30.55N25.32”. If there is no positional information, the system neglects the positional information comparison database 32 and directly undertakes the succeeding steps of edition or display.

Step 704: A webpage server 41 publishes the positional information and related contents of the sender 10, and/or an edit/transmit server 42 edits the positional information and related contents and transmits the edited contents to an issue channel 50. If the positional information is open, the webpage server 41 presents the electronic map and [the landmark+text or audio/video data] on the webpage. If the positional information is not open, the webpage server 41 presents [text or audio/video data] on the webpage. Thereby, any person or the authenticated persons can browse the information uploaded by the sender 10 via the Internet. The edit/transmit server 42 uses an SMS edit/transmit unit to perform edition and transmit a short message [the values of the longitude and latitude and the representative landscape] to the mobile phone of a recipient if the positional information is open. The edit/transmit server 42 uses the SMS edit/transmit unit to perform edition and transmit a short message [your friend (nickname or personal introduction): contents in text] to the mobile phone of a recipient if the positional information is not open. Alternatively, the edit/transmit server 42 uses an MMS edit/transmit unit to perform edition and transmit an MMS message [your friend (nickname or personal introduction): the electronic map+audio/video data (or a website link)] to the mobile phone of a recipient if the positional information is open. The edit/transmit server 42 uses the MMS edit/transmit unit to perform edition and transmit an MMS message [your friend (nickname or personal introduction): audio/video data (or a website link)] to the mobile phone of a recipient if the positional information is not open. Alternatively, the edit/transmit server 42 uses the MMS edit/transmit unit to perform edition and transmit [your friend (nickname or personal introduction): the electronic map+audio/video data (or a website link)] (if the positional information is open) or an MMS message [your friend (nickname or personal introduction): audio/video data (or a website link)] (if the positional information is not open) to the email of a recipient, or the same or compatible program of a wireless Internet-access device of a recipient.

Step 705: An issue channel 50 issues the edited contents to one or more recipients 60. The original positional information and related contents are input by a sender 10 authenticated by the member database 31. The original positional information and related contents are compared with the positional information comparison database 32 and converted into corresponding information. The webpage server 41 publishes the positional information and related contents. The edit/transmit server 42 edits the information to have a format compatible with the device of the recipient 60. Then, the edit/transmit server 42 transmits the [positional information], [the positional information+text or audio/video data] or [the text or audio/video data without the positional information] to the system, and the system issues or publishes the information.

The present invention is characterized in that the communication provider 20 provides passive positioning service for a sender 10, and that the sender 10 obtains the positional information via an electronic mobile device. Alternatively, the user may use the GPS system built in the electronic mobile device to directly obtain the positional information in the present invention. The user can turn on/off the positioning function or open/close the positional information via the application program, the service unit, the selection items, or the vocal system of a universal access number. The sender 10 can use the application program to input the positional information and related contents and transmit the positional information and related contents to the communication provider 20 via a wired or wireless network. The sender 10 can edit the original positional information and related contents into a text dada, a vocal data, or an audio/video data. Then, the system issues or publishes [the positional information], [the positional information+text or audio/video data], or [text or audio/video data without the positional information]. Before the information is issued or published, the member database 31 verifies the identity of the sender 10, and the positional information comparison database 32 compares the positional information with the geographic data thereof and provides corresponding information. Then, the webpage server 41 presents the information on the webpage, whereby the user and others can browse the information. Alternatively, the edit/transmit server 42 edits the information to have a format compatible with the device of the recipient 60. Thereby, the recipient 60 can receive the positional information and related information of the locked-on target in various forms. Further, the recipient 60 can exchange information with the sender 10 in realtime.

The embodiments described above are only to exemplify the present invention but not to limit the scope of the present invention. Any equivalent modification or variation according to the spirit of the present invention is to be also included within the scope of the present invention.

What is claimed is:

1. A permission-based mobile-device positioning system comprising
a communication provider accepting a positioning request of a sender and providing positioning service and content-input service for said sender;
a primary server receiving positional information of said sender and contents input by said sender, which are sent by said communication provider;
a member database storing membership authentication data and personal settings of members and comparing personal data of said sender, which is sent by said primary server, with said membership authentication data to confirm that said sender is an authenticated sender;
a positional information comparison database comparing said positional information obtained by said primary server with a geographic data built thereinside and providing corresponding information;
a webpage server storing said positional information and said contents of said authenticated sender, which are sent by said primary server, and supporting publishing of said positional information and said contents; and
an edit/transmit server editing said positional information and said contents of said authenticated sender, which are sent by said primary server, into edited contents, and transmitting said edited contents to one or more recipients via an issue channel.

2. The permission-based mobile-device positioning system according to claim 1, wherein said sender uses an electronic mobile device to make said positioning request to said communication provider via selecting service items provided by said communication provider, transmitting said positioning request to a universal access number, or dialing said universal access number.

3. The permission-based mobile-device positioning system according to claim 2, wherein said communication provider obtains said positional information of said electronic mobile device of said sender via a telecommunication network.

4. The permission-based mobile-device positioning system according to claim 1, wherein said sender uses a GPS (Global Positioning System) system of an electronic mobile device to obtain positional information and uses an application program to input and transmit said positional information and related contents to said communication provider.

5. The permission-based mobile-device positioning system according to claim 1, wherein said contents input by said sender may be text, voice, audio/video data, pictures, or a combination thereof.

6. The permission-based mobile-device positioning system according to claim 5, wherein said sender uses a transmit/receive application program built in an electronic mobile device to make said positioning request and input/receive said contents.

7. The permission-based mobile-device positioning system according to claim 1, wherein said positional information comparison database compares said positional information with said geographic data built thereinside to provide coordinates, an electronic map, landscapes and an address.

8. The permission-based mobile-device positioning system according to claim 1, wherein said webpage server further comprises a voice display unit, an audio/video display unit, a text display unit and an electronic map display unit.

9. The permission-based mobile-device positioning system according to claim 1, wherein said edit/transmit server further comprises an SMS (Short Message Service) edit/transmit unit and an MMS (Multimedia Message Service) edit/transmit unit.

10. The permission-based mobile-device positioning system according to claim 9, wherein content edited by said SMS edit/transmit unit is text, audio/video data, pictures, animation, or a combination thereof.

11. The permission-based mobile-device positioning system according to claim 1, wherein said communication provider or said issue channel is a telecommunication provider able to provide SMS service or an Internet service provider able to provide MMS service.

12. The permission-based mobile-device positioning system according to claim 1, wherein said recipient responds to said sender through said communication provider.

13. A permission-based mobile-device positioning method comprises steps:
step 1: a sender using an electronic mobile device to make a request for positioning service and/or a request for inputting contents said sender intends to issue;
step 2: a communication provider providing positional information for said sender and receiving said contents input by said sender;
step 3: a primary server receiving said positional information and said contents of said sender from said communication provider, using a member database to verify membership of said sender, and using a positional information comparison database to compare said positional information with a built-in geographic data to provide corresponding information;
step 4: a webpage server publishing said positional information and said contents, and/or an edit/transmit server editing said positional information and said contents into edited contents and transmitting said edited contents to an issue channel; and
step 5: said issue channel issuing said edited contents to one or more recipients.

14. The permission-based mobile-device positioning method according to claim 13, wherein said sender uses said electronic mobile device to make said positioning request to said communication provider via selecting service items provided by said communication provider, transmitting said positioning request to a universal access number, or dialing said universal access number.

15. The permission-based mobile-device positioning method according to claim 14, wherein said communication provider obtains said positional information of said electronic mobile device of said sender via a telecommunication network.

16. The permission-based mobile-device positioning method according to claim 13, wherein said sender uses a GPS (Global Positioning System) system of said electronic mobile device to obtain positional information and uses an application program to input and transmit said positional information and related contents to said communication provider.

17. The permission-based mobile-device positioning method according to claim 13, wherein said contents input by said sender may be text, voice, audio/video data, pictures, or a combination thereof.

18. The permission-based mobile-device positioning method according to claim 13, wherein said positional information comparison database compares said positional information with said geographic data built thereinside to provide coordinates, an electronic map, landscapes and an address.

19. The permission-based mobile-device positioning method according to claim 13, wherein said webpage server further comprises a voice display unit, an audio/video display unit, a text display unit and an electronic map display unit.

20. The permission-based mobile-device positioning method according to claim 13, wherein said edit/transmit server further comprises an SMS (Short Message Service) edit/transmit unit and an MMS (Multimedia Message Service) edit/transmit unit.

21. The permission-based mobile-device positioning method according to claim 13, wherein content edited by said SMS edit/transmit unit is text, audio/video data, pictures, animation, or a combination thereof.

22. The permission-based mobile-device positioning method according to claim 13, wherein said communication provider or said issue channel is a telecommunication provider able to provide SMS service or an Internet service provider able to provide MMS service.

23. The permission-based mobile-device positioning method according to claim 13, wherein said recipient responds to said sender through said communication provider.
